(19) United States
(12) Patent Application Publication
(10) Pub. No.: US 2014/0082003 A1
(43) Pub. Date: Mar. 20, 2014

(54) DOCUMENT MINING WITH RELATION EXTRACTION

(71) Applicant: Digital Trowel (Israel) LTD., Lod (IL)

(72) Inventors: Ronen FELDMAN, Petach Tikva (IL); Benjamin Rozenfeld, Holon (IL)

(73) Assignee: Digital Trowel (Israel) LTD., Lod (IL)

(21) Appl. No.: 14/027,764

(22) Filed: Sep. 16, 2013

Related U.S. Application Data
(60) Provisional application No. 61/701,866, filed on Sep. 17, 2012.

(51) Int. Cl. G06F 17/30

(52) U.S. Cl. CPC G06F 17/30699
USPC 707/755

(57) ABSTRACT

A document mining method includes automatically parsing each sentence of a corpus of documents into constituents. If some of the constituents correspond to entities from a list of recognized entity types, a relation between those entities, the relation including the entities and a link between them, is automatically identified. If the relation is identified in a predetermined number of sentences of the corpus, a relation extraction rule is automatically created. The relation extraction rule is applicable to a document to enable automatic retrieval of information that corresponds to the relation from that document.

### CROSS REFERENCE TO RELATED APPLICATIONS

The present invention claims the priority benefit of U.S. provisional patent application No. 61/701,866 filed on Sep. 17, 2012, which is incorporated in its entirety herein by reference.

### FIELD OF THE INVENTION

The present invention relates to document mining

### BACKGROUND OF THE INVENTION

In many situations, automatic document mining, or extraction of data from documents (e.g., that are accessible via a network) is highly desirable. For example, medical forums contain valuable information for medical researchers, for pharmaceutical companies, or even for patients. The problem is that the valuable information is often hidden inside the chatter of these forums. Similarly, financial news websites and blogs contain a seemingly infinite stream of financial and business information that impacts decision makers and the stock market. With thousands of news articles and blog posts published every day, it is impossible for a human reader to go over all these texts, extract and analyze valuable information, recognize risks and opportunities, and respond in a timely fashion. Similar situations exist for other areas of human activity.

Conventional search engines for searching sets of documents, available either locally or via a network, are based on keywords. A user inputs a set of keywords that are expected to appear in a document of interest. The search engine then returns documents that include those words. In order to perform a comprehensive search, the user must input all of the possible synonyms or alternative phrasing for each keyword.

In many cases, a search may be better defined by a relationship, rather than by keywords. There are several possible general approaches to the problem of extracting relations, which can be classified along two orthogonal dimensions: the degree of using machine learning (ML) during the system preparation stage, and the degree of using syntactic information.

At the lowest end of the scale are systems that use no ML and no syntactic information. Such an extraction system could be constructed by manually writing the extraction patterns, using a formalism such as regular expressions, context-free grammar (CFG), or a more powerful grammar class, which would work directly on the input text. Such approaches require a prohibitive expenditure of expert-level human effort, and are generally obsolete nowadays.

A linguistically sophisticated no-ML approach could start with a general-purpose syntactic parser. With all sentences pre-processed by a parser, it would be possible to write the extraction patterns at the level of the syntactic parse. The main disadvantage of this approach (besides requiring a significant human effort) is its low accuracy, due to mistakes made by present-day general-purpose parsers. This is especially true for messages that are posted in network forums, which frequently contain poor grammar and many errors.

An ML-based syntactically simple approach could start with a labeled training set. Such a system could be trained on a set of texts manually labeled with instances of the target relations. It would try to automatically learn the extraction patterns, which can be either used directly, or as features for a classifier such as a support vector machine (SVM). This approach requires less human labor than the aforementioned approaches since the training set need not be labeled by an expert, but only by one who understands the language of the training set.

State-of-the-art semi-supervised and unsupervised web relation identification and extraction systems usually employ linguistic analysis limited to noun phrase (NP) chunking, although some include deep parsing (usually, dependency-based) for at least some of the data.

### SUMMARY OF THE INVENTION

There is thus provided, in accordance with some embodiments of the present invention, a document mining method including: automatically parsing each sentence of a corpus of documents into constituents, and, if some of the constituents of the sentence correspond to entities from a list of recognized entity types, automatically identifying a relation between those entities, the relation including the entities and links between them; and if the relation is identified in a predetermined number of sentences of the corpus, automatically creating a relation extraction rule that is applicable to a document to enable automatic retrieval of information that corresponds to the relation from that document.

Furthermore, in accordance with some embodiments of the present invention, automatically parsing each sentence includes applying a rulebook to each sentence.

Furthermore, in accordance with some embodiments of the present invention, the method further includes modifying the rulebook in accordance with a recurring pattern that is detected in a set of domain-relevant sentences.

Furthermore, in accordance with some embodiments of the present invention, the method further includes re-parsing a sentence after modification of the rulebook.

Furthermore, in accordance with some embodiments of the present invention, the relation extraction rule consists of a set of head-driven phrase structure grammar (HPSG) lexicon entries.

Furthermore, in accordance with some embodiments of the present invention, the corpus of documents is a local corpus.

Furthermore, in accordance with some embodiments of the present invention, the corpus of documents is accessible via a network.

Furthermore, in accordance with some embodiments of the present invention, the method further includes identifying and creating an extraction rule for a modifier of the identified relation.

Furthermore, in accordance with some embodiments of the present invention, the method further includes receiving from a user the list of recognized entity types.

Furthermore, in accordance with some embodiments of the present invention, the method further includes automatically naming the relation.

Furthermore, in accordance with some embodiments of the present invention, creating the relation extraction rule includes automatically clustering a plurality of the identified relations in accordance with similarity criteria.

There is further provided, in accordance with some embodiments of the present invention, a document mining method including applying a relation extraction rule to a sentence of a document to extract a relation regarding one or more entities that are named in the sentence, the relation extraction rule created by automatically detecting patterns of identified relations among recognized entity types in parsed sentences of a corpus of documents.

Furthermore, in accordance with some embodiments of the present invention, sentences of the corpus of documents are parsed to form the parsed sentences by application of the rulebook to the sentences.

Furthermore, in accordance with some embodiments of the present invention, the rulebook is modified after detection of the patterns.

Furthermore, in accordance with some embodiments of the present invention, a sentence of the sentences of the corpus of documents is re-parsed after the rulebook is modified.

Furthermore, in accordance with some embodiments of the present invention, the relation extraction rule includes a set of head-driven phrase structure grammar (HPSG) lexicon entries.

There is further provided, in accordance with some embodiments of the present invention, a document mining system including a processor, the processor being in communication with a computer readable medium, wherein the computer readable medium contains a set of instructions wherein the processor is further configured to carry out the set of instructions to: automatically parse each sentence of a corpus of documents into constituents, and, if some of the constituents of the sentence correspond to entities from a list of recognized entity types, automatically identify a relation between those entities, the relation including the entities and a link between them; automatically create a relation extraction rule that is applicable to a document to enable automatic retrieval of information that corresponds to the relation from that document, if the relation is identified in a predetermined number of sentences of the corpus; and apply the relation extraction rule to a sentence of a document to extract a relation regarding one or more entities that are named in that sentence.

Furthermore, in accordance with some embodiments of the present invention, the processor is configured to access the corpus of documents via a network.

### BRIEF DESCRIPTION OF THE DRAWINGS

In order to better understand the present invention, and appreciate its practical applications, the following Figures are provided and referenced hereafter. It should be noted that the Figures are given as examples only and in no way limit the scope of the invention. Like components are denoted by like reference numerals.

FIG. 1 is a schematic diagram of a system for document mining, in accordance with an embodiment of the present invention.

FIG. 2 is a flowchart depicting a method for document mining, in accordance with an embodiment of the present invention.

FIG. 3 is a schematic diagram of architecture of an application for document mining, in accordance with an embodiment of the present invention.

FIG. 4 is a schematic diagram of operation of preparation of a generic preparation module of the application for document mining shown in FIG. 3, in accordance with an embodiment of the present invention.

FIG. 5 is a schematic diagram of operation of a domain-specific preparation module of the application for document mining shown in FIG. 3, in accordance with an embodiment of the present invention.

FIG. 6 is a schematic diagram of operation of a information extraction module of the application for document mining shown in FIG. 3, in accordance with an embodiment of the present invention.

FIG. 7 is a schematic diagram of operation of a lexicon acquisition process of the application for document mining shown in FIG. 3, in accordance with an embodiment of the present invention.

### DETAILED DESCRIPTION OF THE INVENTION

In the following detailed description, numerous specific details are set forth in order to provide a thorough understanding of the invention. However, it will be understood by those of ordinary skill in the art that the invention may be practiced without these specific details. In other instances, well-known methods, procedures, components, modules, units and/or circuits have not been described in detail so as not to obscure the invention.

In accordance with embodiments of the present invention, document mining is used to retrieve relevant information from documents. The document mining is based on automatic identification of relations and automatic creation of relation-extraction rules from a corpus of documents. The corpus of documents may be accessible via a network. For example, the corpus may be accessible via one or more websites that are associated with a particular domain. As used herein, a domain refers to a particular field of knowledge or subject area. Examples of domains include medicine, finance, or other fields of science, technology, or human activity.

Sentences of each of the documents in the corpus are identified. Each sentence of the document is automatically parsed. The parsing creates a structure for each sentence, containing lexical constituents and links (syntactic and semantic) between them. Some of the constituents of a parsed sentence may be identified as corresponding to one or more recognized entity types. A set of parsed sentences whose constituents include the recognized entity types may be subjected to a further analysis. The analysis detects patterns that occur in a plurality of the parsed sentences. Such a pattern includes one or more entity constituents that are linked in a particular manner. A pattern may also include other constituents (e.g., corresponding to modifiers or other parsed constituents).

Relation extraction rules may be automatically created on the basis of the detected patterns. For example, a relation extraction rule may correspond to a described event or occurrence in which a particular action or result is associated with an entity of a particular type. For example, relation extraction rule may specify that a first entity (of a first type) performed an action on a second entity of the same or of another type (e.g., a financial organization acquired another organization, or a person or organization hired a person). As another example, a relation extraction rule may specify that one entity resulted in another entity (e.g., use of a particular drug resulted in a particular side effect, or that a particular disease was cured by a particular drug). The relation extraction rules are based on a head driven phrase structure grammar (HPSG).

The relation extraction rules may be incorporated in a rulebook. The rulebook may be utilized to locate information in documents. For example, a document search engine may be configured to locate documents via a network. Sentences may be identified in each located document. The identified sentences may be parsed (e.g., in accordance with a generic parser or in accordance with a domain-specific rulebook). The relation extraction rules may be applied to the parsed sentences to extract relations from those sentences. For example, the parsed constituents of a sentence may correspond to a pattern that is included in a relation extraction rule. Application of the relation extraction rule may then extract information from the parsed sentence. The extracted information may be stored or marked in a retrievable manner (e.g., a database or in another manner). The stored extracted information may then be searched to retrieve part or all of the stored information. For example, a search may retrieve all extracted information that is related describes acquisitions by a particular company, or all reported side effects to use of a particular drug.

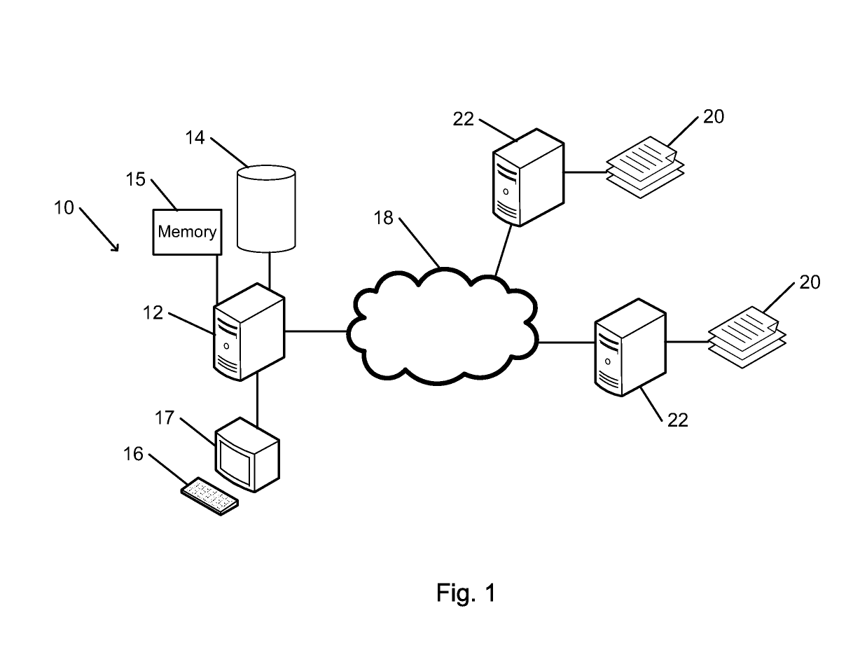

FIG. 1 is a schematic diagram of a system for document mining, in accordance with an embodiment of the present invention.

Document mining system 10 includes processor 12. For example, processor 12 may include one or more processing units, e.g. of one or more computers. Processor 12 may be configured to operate in accordance with programmed instructions stored in memory 15. Processor 12 may be capable of executing an application for document mining that includes automatic identification of relations and automatic creation of relation-extraction rules from a corpus of documents.

Processor 12 may communicate with output device 17. For example, output device 17 may include a computer monitor or screen. Processor 12 may communicate with a screen of output device 17 to display results of document mining, or a user interface to enable control of document mining based on automatic identification of relations and automatic creation of relation-extraction rules from a corpus of documents. In another example, output device 17 may include another component (e.g., printer, display panel, speaker, or other device) capable of producing visible, audible, or tactile output.

Processor 12 may communicate with input device 16. For example, input device 16 may include one or more of a keyboard, keypad, touch screen, or pointing device for enabling a user to inputting data or instructions for operation of processor 12.

Processor 12 may communicate with memory 15. Memory 15 may include one or more volatile or nonvolatile memory devices. Memory 15 may be utilized to store, for example, programmed instructions for operation of processor 12, data or parameters for use by processor 12 during operation, or results of operation of processor 12

Processor 12 may communicate with data storage device 14. Data storage device 14 may include one or more fixed or removable nonvolatile data storage devices. For example, data storage device 14 may include a computer readable medium for storing program instructions for operation of processor 12. It is noted that storage device 20 may be remote from processor 12. In such cases storage device 20 may be a storage device of a remote server storing programmed instructions in the form of an installation package or packages that can be downloaded and installed for execution by processor 12. Data storage device 14 may be utilized to store data or parameters for use by processor 12 during operation, or results of operation of processor 12.

In particular, data storage device 20 may be utilized to store relations and relation-extraction rules for use in document mining, in accordance with an embodiment of the present invention. Data storage device 20 may be utilized to store a local corpus of documents or sentences.

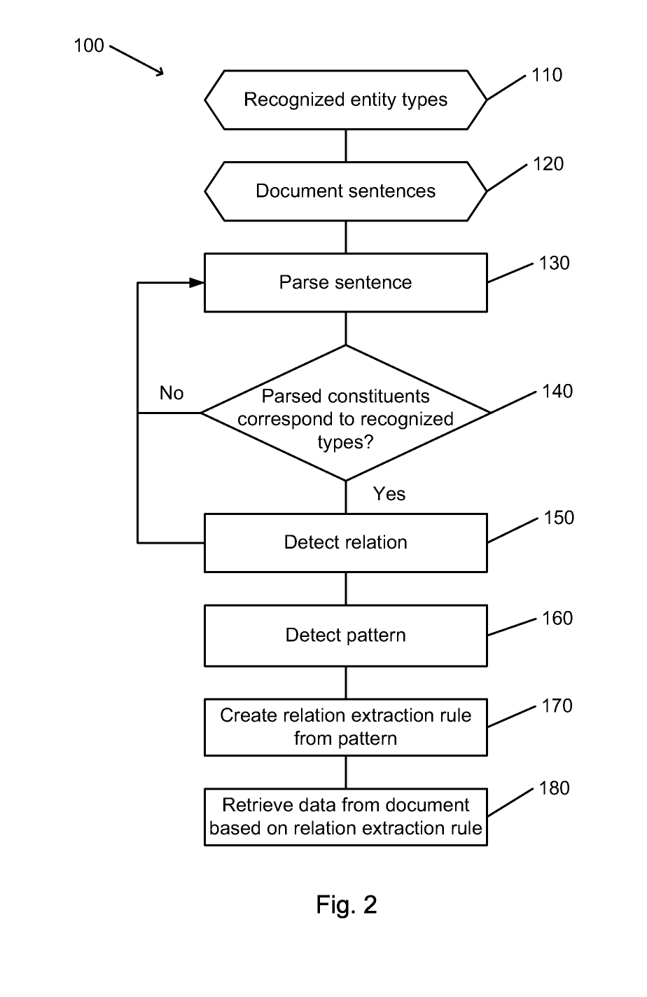

FIG. 2 is a flowchart depicting a method for document mining, in accordance with an embodiment of the present invention.

It should be understood with respect to any flowchart referenced herein that the division of the illustrated method into discrete operations represented by blocks of the flowchart has been selected for convenience and clarity only. Alternative division of the illustrated method into discrete operations is possible with equivalent results. Such alternative division of the illustrated method into discrete operations should be understood as representing other embodiments of the illustrated method.

Similarly, it should be understood that, unless indicated otherwise, the illustrated order of execution of the operations represented by blocks of any flowchart referenced herein has been selected for convenience and clarity only. Operations of the illustrated method may be executed in an alternative order, or concurrently, with equivalent results. Such reordering of operations of the illustrated method should be understood as representing other embodiments of the illustrated method.

Document mining method 100 may be executed by a processor of a system for data mining Document mining method 100 may be executed upon a request or command that is issued by a user, or automatically issued by another application (e.g., upon entering parameters or instructions that enable execution of document mining method 100).

Document mining method 100 may be executed on the basis of a set of one or more recognized entity types (block 110). For example, the recognized entity types may have been selected by a user, or may have been selected automatically by an application for facilitating document mining. A recognized entity type may be selected by a user from a list of possible entity types, or may be defined by a user. For example, a generic term for a recognized entity type may be entered (e.g., drug, symptom, organization, individual, currency, or other term), or a list of examples (e.g., in the form of common or proper nouns) of the desired entity type may be entered. Designation of a recognized entity types may include a list of terms that correspond to that recognized entity type, or a pointer to a resource (e.g., stored database, network-accessible directory, or other resource) that includes terms that correspond to that recognized entity type.

Document mining method 100 may be executed on the basis of a set of document sentences (block 120). For example, the sentences may have been detected by a sentence detection application in documents of a corpus of documents. The corpus of documents may be domain specific, having been selected as one whose sentences are expected to include relationships among the recognized entity types (e.g., articles related to pharmacology or medicine for relations among drug- or medical-related entities, or articles related to business or finance for relations among business- or finance-related entities).

Each sentence of the set of document sentences is parsed into a structure (block 130). The parsed structure indicates lexical constituents of the sentence, as well as syntactic and semantic between the constituents. (The parsed structure may be represented graphically as a tree, in which each node corresponds to a lexical constituent or to a syntactic unit that includes two or more syntactically-related constituents.) The parsing may include application of a generic parser (e.g., that is configured to parse sentences that are written in a particular language). The parsing may include application of domain-specific parsing. For example, a domain-specific parsing may be enabled as a result of unsupervised domain-specific lexicon construction, as part of a pattern detection process (e.g., as in the operation that is represented by block 150). In this case, a sentence may be reparsed after the domain-specific lexicon is constructed.

One or more of the parsed lexical constituents of a parsed sentence may correspond to a recognized entity type (block 140). For example, a noun, or modified noun, in the sentence may be identified (by comparison with a list in a database or other resource) as belonging to a recognized entity type (e.g., with the examples that were described above, a name of a drug, a name of a symptom, an organization, or a person, or other entity type).

If no lexical constituents correspond to recognized entity types, other sentences (if any) from the corpus of documents continue to be searched (returning to operation indicated by block 130).

If a lexical constituent corresponds to a recognized entity type, a relation may be detected (block 150). For example, a relation may indicate a causal relationship between one entity and another (e.g., drug and symptom or side effect), or an action performed by one entity, e.g., with respect to another (e.g., one company acquiring another, or hiring a person). Other types of relations may be detected. A detected relation may be permanently or temporarily stored for further analysis. Parsing continues on other sentences from the corpus of documents until all (or a predetermined fraction or number) of the sentences are parsed and analyzed (returning to operation indicated by block 130).

The detected relations may be analyzed to detect a pattern of recurring relations (block 160). For example, several detected relations may be determined to represent the same relation. Equivalence of two or more relationships may be automatically determined with reference to one or more indications. Such indications may include, for example, equivalent meanings of a word that describes a relationship between entities (e.g., as determined by detected synonyms in a thesaurus resource or similar resource), a syntactic equivalence between the relations (e.g., one is a syntactic transformation of the other), equivalence of the entity types that participate in the relations, or other indications. Clusters of equivalent or similar relations may be formed.

A relation extraction rule may be created from the detected pattern (block 170). The relation extraction rule may be in the form of an HPSG lexicon entry in a rulebook. Application of the relation extraction rule to a parsed sentence of a document may yield a relation between entities that are included in the parsed sentence.

The created extraction rules (in the form of HPSG lexicon entries) are then automatically used by the parser, so relation instances become natural parts of the sentence's parse structure. Relation instances can be retrieved from parses of sentences of a document as the information extracted from the document (block 180). For example, data may be extracted on an ongoing basis (“web crawling”) from documents that are accessible via a network (e.g., the Internet). Such a process is referred to as document mining. The extracted data may then be searched or queried to retrieve information of interest from the extracted data. For example, the extracted data may include a set of entities that are related in a particular manner (e.g., company X acquired company Y, drug X caused side effect Y). The extracted data may then be searched to retrieve data that is related to a particular entity (e.g., a particular drug or company).

The task of extracting a useful knowledge base from a large set of text documents is a natural application for supervised, or semi-supervised, relation extraction (RE). Given an input text document, the task of RE is to find within the text any mention of interesting relations between zero or more named entities. Unless RE is totally unsupervised, the interesting entity types and relation types are known in advance.

For example, in the context of a drug study, there may be two defined entity types: DRUG and SYMPTOM. DRUG instances are names of medications, either generic or brand names. SYMPTOM instances include noun phrase descriptions of possible adverse reactions. In the context of finance, entities may be: PERSON, COMPANY, LOCATION, and MONEYAMOUNT.

For example, it may be known in advance that we are interested in two relation types in the medical field: SideEffect and DrugReplacement. The instances of SideEffect indicate that a certain drug has a certain side effect. The slots are Drug and Symptom. The instances of DrugReplacement indicate that a user replaced one medication with another. Its slots are Drug, Replacement, and Reason. The Reason slot is special in that its values are not entities but free-form pieces of sentences.

For example, a sentence reads:

I was on adderall which was great, but it would give me a stomach ache for a short time after each dose, and bad night sweats.

The relation included in the sentence may be expressed as:

SideEffect:
Drug=“adderall”
Symptom=[“stomach ache”, “bad night sweats”]

Another sentence reads:

the dr wants me to go off the avandamet and just take straight metformin for a week to see if it still causes me nausea

DrugReplacement:
Drug=“avandamet”
Replacement=“metformin”
Reason=“to see if it still causes me nausea”

For the financial domain, we may be interested in many different relations, such as: Acquisition, JointVenture, Employment, Lawsuit, or others. The set of interesting relations is not specified in advance for this domain, so the relation identification is particularly relevant. For example, a sentence reads:

As part of the joint venture arrangement, Carpenter Technology will acquire a 40 percent interest in Carpenter Powder Products AB.

with a relation being expressible as

Acquisition:
Aquirer=“Carpenter Technology”
Aquiree=“Carpenter Powder Products AB”
Part=“40 percent”

Relation extraction, in accordance with embodiments of the present invention, instead of using separate extraction patterns to be matched on parses produced by a general-purpose parser, blends the extraction patterns directly into the parser's lexicon, which has both syntactic and semantic parts, according to the principles of HPSG grammar theory. Thus, instead of a set of patterns, a relation extraction system built using this framework consists of a set of domain-specific lexical entries. This domain-specific lexicon is automatically learned from a large unlabeled corpus.

Only minimal human assistance is required during the system preparation stage. This assistance may include filtering out any uninteresting relations that can be learned from the unlabeled corpus, and supervising (e.g., by checking and by fixing errors in) the results of the automatic relation clustering.

The resulting RE system performs better than systems built upon general-purpose parsers. The reason is that while general-purpose parsers try to optimize the overall quality of their parsers, our parser is purposely built to optimize its accuracy on a very small subset of the input—precisely the parts of sentences that contain useful relations—without caring for its performance on the rest of the text. For the same reason, the frequent ungrammaticality of the input text is less problematic.

In accordance with embodiments of the present invention, a domain-independent framework is provided for building an information extraction system. The framework includes a grammar description language and supporting tools. The core of the framework is a parser, which is capable of parsing an arbitrary weighted typed-feature-structure context-free grammar (WTFSCFG). A WTFSCFG is a weighted context-free grammar (CFG) in which every matched symbol, either terminal or non-terminal, carries a typed feature structure. The grammar rules have access to feature structures of their component symbols, building from them the feature structures for their heads, by applying the operations of unification, slot extraction, and slot removal.

In accordance with embodiments of the present invention, the grammar is based on principles of HPSG grammar theory. The grammar's lexicon is largely underspecified. Only the most frequent and functional words have full definitions, while the open classes of words are defined using generic underspecified lexical entries and tightly integrated feature-rich sequence classification models for part-of-speech tagging (PoS) and named entity recognition (NER). The models provide weights for different possible typed-feature-structure assignments. Then, for any input sentence, the parser generates a single highest-weight parse—the parse which is the most consistent with both the grammar rules and the NER and PoS classifiers.

This architecture results in a relatively fast parser (e.g., with a speed around 300 KB/min per processing thread on a 3 GHz CPU). The quality of the parsing is improved by extension of the grammar with a small set of domain-specific lexicon entries for the domain-specific relations that may be of interest. Such a system may be more robust than a general parser when handling big and complex sentences, and in the presence of bad grammar

The domain-specific lexicon entries also carry semantic information, in the HPSG style. This allows immediate and straightforward extraction of the relation and its slots as soon as a parse is generated.

For example, a general-purpose parser (Charniak parser) applied to the following sentence:

I had severe knee swelling and pain from Levemir insulin and the dr doesn't think Levemir had anything to do with the severe pain because knee swelling wasn't listed as a side effect even though hand and foot swelling was.

was found to have missed the important domain-specific relation between “knee swelling” and “Levemir insulin” by forming a noun phrase “pain from Levemir insulin and the dr” and interpreting it as the subject of “doesn't think”. In the absence of semantic information, such errors are easy to make.

A general-purpose parser applied to the following sentence:

Financial Systems Innovation LLC has entered into a settlement agreement covering a patent that applies to credit card fraud protection technology with Lone Star Steakhouse, Inc.

erroneously attached “with Lone Star Steakhouse, Inc” to the immediately preceding “credit card fraud protection technology” instead of to “settlement agreement”.

In both cases, relation extraction, in accordance with embodiments of the present invention, was able to parse the relevant sentence parts correctly, due to the parsers being able to use semantic information to help its decisions. The focused domain-specific lexical entries, learned automatically from simpler sentences with more straightforward parses, have higher weight than the generic lexical entries, and increase the chances of correct parsing. In the first sentence, the important domain-specific words are the particular form of the verb “have” and the preposition “from”, as in the pattern “PersonX has SideEffectY from DrugZ”. In the second sentence, it is three words: “enter”, “agreement”, and the preposition “with”, as in the pattern “CompanyX enters into agreement with CompanyY”. Note, that the entries in the domain-specific lexicon, after they were learned from simple patterns like these, are able to perform extraction in much more general contexts, as demonstrated by the second sentence. The words participate in all the general linguistic rules defined by the HPSG grammar, such as agreement, passive voice, negation, rearranging of preposition phrases order, and conjunctions.

Relation extraction, in accordance with embodiments of the present invention, may be incorporated in an integrated development environment (IDE) for building domain-specific relation extraction systems based on HPSG. The IDE may integrate tools for managing named entity definitions, managing corpora, automatic learning of a lexicon, pattern clustering (relation identification), and co-reference resolution.

Most of the process of building relation extraction rules occurs within the IDE. The exceptions are the initial corpus preparation (downloading, extracting text, separation into sentences) and domain-specific post-processing, if required.

A newly created relation extraction project contains only the generic grammar and the standard set of named entities (PERSON, ORGANIZATION, LOCATION, and DATE, available from a named entity recognition (NER) sequence classifier, CRF-trained on the data from CoNLL-2003 shared task language). If additional domain-specific entity types are needed, their definitions must be supplied. Then, a corpus of domain-related sentences must be added to the project. This starts the pattern extraction and lexicon acquisition process. The extracted patterns may be clustered, filtered, and optionally renamed, which completes the relation identification and lexicon acquisition processes.

This ends the part of the development cycle that can be done within the IDE framework. The final development stage may also include domain-specific post-processing. In our case studies, only relations in the medical domain need this stage, which is implemented as a simple Pert script.

In addition to these stages, the full system also includes a co-reference resolution module, which is active during actual relation extraction.

The first step is to define the relevant nonstandard entity types. Within the framework, entities can be defined in several different ways: using a separately-trained NER model, relation extraction rules, relation extraction lexicon definitions, or lists of allowed values (for entity types for which the sets of entities are closed). Arbitrary mixing of these methods is also possible and effective.

For example, in the medical domain, DRUG and SYMPTOM entity types may be required, the instances of which are the names of medications and descriptions of side effects, respectively. The DRUG entity type may be primarily defined using a list of known drug names, with an addition of a small set of extra lexical entries, which extend the coverage of the list. The list of known drug names may be built automatically, with reference to available resources (such as www.drugs.com). Additional lexical entries are needed since, for example, for the purposes of extracting DrugReplacement and DrugSideEffect terms, the phrases “Byetta”, “Byetta pill”, “a dose of about 100 mg of Byetta a day” are all equivalent. However, in terms of the generic grammar, they are not equivalent, because the heads of the noun phrases are different: “Byetta” (DRUG), “pill” (generic common noun), and “dose” (different generic common noun), respectively. In order to make the longer phrases equivalent to a simple DRUG entity, it is sufficient to add the lexical entries for the possible head words: “pill”, “dose”, “mg”, and several others. They must be defined as nouns with a special “nform”, which is changed to nform_DRUG if the nouns are modified by a possessive construction headed by an nform_DRUG noun. In this case, the semantics of the possessive must also add a link from the modified noun to the modifier DRUG entity.

Extracting SYMPTOM terms may be more complex. As with the drugs, we may start by building a list of known symptoms from a resource (e.g., www.drugs.com). Each listed drug may be accompanied by list of possible symptoms indicating its use. Combining the lists from all of the listed drugs may result in a dictionary to be used in creating a set of rules. These rules may break down the symptoms to their components: the problem nouns (e.g., “acid”, “bleeding”, “ache”), problem adjectives (“abnormal”, “allergic”), body part (“abdomen”, “ankle”), behavior (“appetite”, “balance”, “mood”, “sleep”). These components may then be added as domain-specific lexical entries, with the semantics that would allow them to form full symptom names by combining with each other in any syntactically-licensed manner.

As another example, in the financial domain, entities may defined using the standard sequence classification model that CRF-trained on a manually-labeled corpus. An entity such as MONEYAMOUNT may be defined by directly using rules.

The second step is to add to the project an unlabeled corpus—a set of domain-relevant sentences—and to run the pattern learning and lexicon acquisition process. The IDE may use the unlabeled corpus for discovering linguistic patterns that can be directly translated into lexicon definitions, e.g., as described by B. Rozenfeld and R. Feldman in Unsupervised Lexicon Acquisition for HPSG-Based Relation Extraction in Proceeding of the Twenty-Second International Joint Conference on Artificial Intelligence (2011), incorporated herein in its entirety by reference.

The patterns whose corpus frequency exceeds a threshold (e.g., 2) are considered to represent lexicon definitions, are added to the project, and the affected parts of the corpus are automatically reparsed.

For example, in one test with regard to the medical domain, a corpus of sentences was extracted from posts and comments downloaded from various websites related to diabetes. For the financial domain, a corpus of 200,000 sentences was extracted from financial news websites.

The extracted patterns are named using their components, and each pattern defines one or several lexical entries. For example, a pattern that is named: Rel_ORG_enter_into_agreement_with_ORG may add four entries: the prepositions “into” and “with”, the noun “agreement”, and the verb “enter”. “Into” may be defined as an argument preposition, “agreement” may be defined as a noun with a special SYN.HEAD.FORM and without any non-generic semantics, and “enter” may be defined as a verb with three complements and with the output relation semantics. The definitions of non-pattern-specific words, such as “into”, “with” and “agreement” can be reused by many patterns.

The pattern names show only the complements—the required pieces of the pattern. The actual instances of the relation may also contain optional pieces, specified by modifiers.

For example, some sentences may contain negated or modal relations. For example:

Nestle S. A. (NESN.VX), the world's largest food and beverages producer, Tuesday said it won't bid for UK-based confectionery company Cadbury Plc (CBY).

The syntax and semantics of such forms may be handled in the generic grammar in a way compatible with the HPSG grammar theory. In practice, if either the main verb or one of the slots of a relation is modified by a negating or modal modifier (“not” and its various forms, auxiliary modal verbs, and other negating or modality-specifying words), then the extracted relation is marked as negated and/or modal.

The identified patterns may be clustered based on similarity criteria, and the resulting output relations may be defined or named. The similarity criteria may be based on similarity of internal structure or semantic proximity of the constituents of the pattern. Irrelevant patterns may be removed, e.g., for cosmetic or performance reasons. The IDE may include automatic clustering capability as well as a graphical user interface (GUI) to enable manual clustering or manual modification of the results of automatic clustering.

A clustering algorithm may use a variant of hierarchical agglomerative clustering (HAC) with single linkage. When estimating a semantic distance between patterns, the clustering algorithm may take into account their direct similarity in addition to similarity of their extractions. The similarity criteria (direct similarity estimation) takes into account: the structural similarity between patterns, including standard syntactic transformations; identity of their slots' entity types; identity or synonymy or other association between specific words in the patterns as discovered using an appropriate resource (e.g., WordNet).

Besides being desirable from general principles, direct similarity may be required for clustering infrequent patterns. A pattern may be based on as few as two supporting mentions. Such small extraction sets usually have empty intersections and so are not useful for estimating similarity of patterns that produce them.

Since the automatic clustering may not produce perfect clustering, human supervision of the clustering process may be enabled. Also, human supervision may enable renaming the clusters and their slots as needed.

For example, in the medical domain, only a few select relations may be of interest and most of the patterns may be deleted. Those select relations may be gathered into several clusters, such as, for example: StopUsingDrug(Person, Drug), StartUsingDrug(Person, Drug), UseDrug(Person, Drug), HasSymptom(Person, Symptom), and CauseSymptom(Drug, Symptom). StopUsingDrug may be used as a main component of a full DrugReplacement relation, for which the UseDrug and StartUsingDrug may supply additional slot values. Similarly, CauseSymptom may be a main component for the SideEffect relation, which can also be formed from a combination of one of the UseDrug relations and a HasSymptom relation.

Thus, it is sometimes necessary to create a full final relation instance from two or more separate simpler relation instances, for example if they appear in separate sentences. A separate post-processor may perform this task. The post-processor for the medical domain relations is described below.

As another example, in the financial domain, all reasonably meaningful relations between the available entities may be of interest.

Optional arguments of a relation are usually represented in natural language by modifiers—syntactic constructions that add to the semantics of a head phrase without significantly affecting its syntactic properties. A lexicon acquisition module may be configured to identify and learn common modifier patterns: such as preposition phrase modifiers and possessive construction modifiers.

Preposition phrase (PP) modifiers have the form of a preposition complemented by a noun phrase (<prep> NP), and can modify verb and noun phrases. A generic grammar may include default lexical entries for all prepositions, which allow any PP to modify any NP or verb phrase (VP). The default prepositions have empty semantics, and so do not affect outputs of parses in which they participate.

Possessive construction modifiers always modify noun phrases. They have three syntactically different but semantically identical forms: possessive determiner form (X's <noun>), compound noun form (X <noun>), and of-preposition phrase form (of X). Just as for generic PP-s, a grammar may include default definitions for generic compounds and generic possessives.

In order for a non-default domain-specific modifier to be useful, and therefore learnable, its NP part must contain a relation argument—extractable entity—either directly, as in:

In January 1997, Hays bought German distributor Daufenbach for 30 million GBP, . . .

or via a PP-NP chain, as in:

Ms. Bennett succeeds William J. Viveen, Jr., as a member of the Interleukin Board of Directors.

During learning, the lexicon acquisition component notices candidate modifier patterns and are considered to be patterns if their frequency rises above the threshold. A candidate modifier pattern is a generic modifier attached to an identified domain-specific relation, and whose NP part contains an extractable entity. For example, assuming the verb relation patterns Rel_ORG_buy_ORG and Rel_PERSON_succeed_PERSON are already learned, the two sentences above would generate the PP modifier patterns Mod_verb_in_DATE and Mod_verb_as_member_of_ORG. If the pattern Rel_ORG_control_ORG is already learned, then the sentence:

Codan is controlled by Royal & Sun Alliance Group PLC of the U.K.

would generate a potential possessive modifier pattern Mod_ORG_of_LOCATION.

Patterns are converted into lexical entries and added to the domain-specific lexicon.

Modifiers are cross-pattern: the same PP modifier can attach to phrases extracting different relations, and the same possessive modifier can attach to nouns of the same type within different patterns. It is possible to precisely fine-tune the scope of a modifier using a GUI manual control—to specify the relations and clusters to which the modifier is applicable, and, for each relation and cluster, the slot name of the argument that the modifier extracts. Thus, the scope of Mod_verb_as_member_of_ORG can be limited to the ManagementChange cluster, and the extracted slot can be specified as EMPLOYER.

It is possible in principle to automatically select the modifier scope and, if not precisely rename, then at least to unify (where appropriate) the slots extracted by different modifiers and/or mandatory relation arguments. However, human intervention may be utilized in which co-occurrences of relation instances extracted by different patterns are observed.

For example, extraction of the ‘Reason’ slot of the DrugReplacement relation may not be automatically learned, because reasons are not well-defined and are not proper named entities. However, most of the mentions of reasons in sentences have very specific syntactic forms: they are adverbial modifier phrases headed by either VP-INF-complemented “in order to” (or simply “to”), or S-FIN-complemented “because” or “since”, or NP-complemented “due to” or “because of”, or NP-complemented “for”, where the complement NP must be headed by “reason”, “matter”, or “purpose”. All of these forms can be specified by manually defining a small set of lexical entries. The resulting definitions are, in fact, generic, and not domain-specific. They can be added to the generic grammar, and can be used in any future project that requires extraction of ‘reasons’ of this kind.

Many relation mentions refer to their argument via co-references, such as pronouns, general nouns, or acronyms. Resolution of co-references may be based on locating all noun phrases, identifying their properties, and then clustering them in several deterministic iterations (called sieves), starting with the highest-confidence rules and moving to lower-confidence higher-recall ones. Within each iteration the order of candidate checks is deterministic, and any matching noun phrases with matching properties are immediately clustered together.

This method may be especially suitable where all of information that the method requires is already extracted: the noun phrases are located from the parses, together with their properties, which are identified from HPSG feature structures.

The co-reference resolution module attempts to resolve all noun phrases, although non-entity ones are discarded. This is necessary for improving the accuracy on the relevant entity mentions, by removing irrelevant candidates.

Sometimes, a relation is split into several clauses, which are either coordinated by a conjunction, or simply reside in separate sentences. Each of the clauses may contain instances of simpler patterns, which supply the various slots in the whole relation. The task of building a complex relation from its pieces may be performed at a later post-processing stage. In post-processing, the slots of any adjacent relation-pieces are merged, if the pieces are compatible, that is, if relation types are correct for merging, and if none of the slots contradict each other.

For example, in the DrugReplacement relation, StopUsingDrug can merge with StartUsingDrug and with UseDrug. For the SideEffect relation, HasSymptom can merge with any of StartUsingDrug, StopUsingDrug, or UseDrug. After merging, all StartUsingDrug, UseDrug, and HasSymptom relations that were not identified as parts of a larger relation can be removed, since only in the full DrugReplacement and SideEffect relations may be of interest.

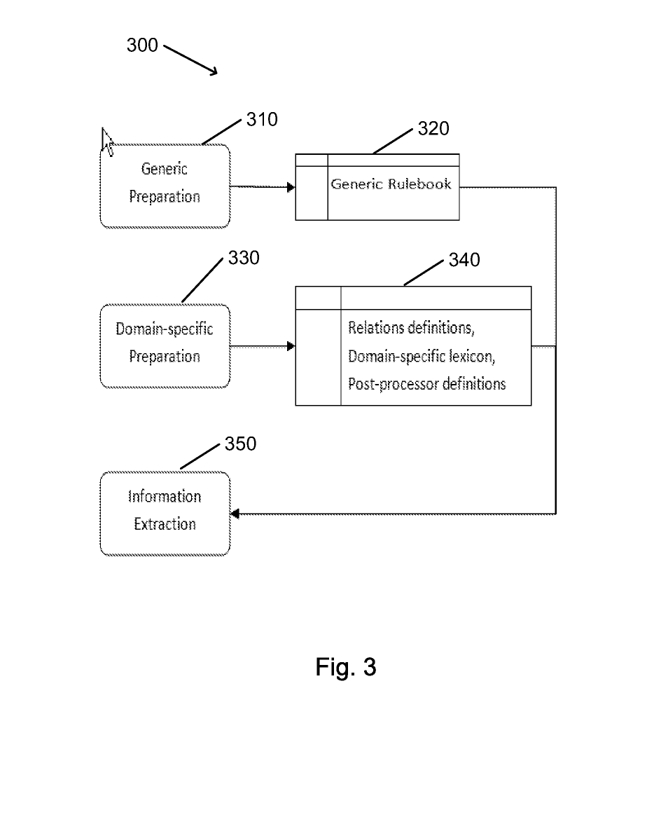

FIG. 3 is a schematic diagram of architecture of an application for document mining, in accordance with an embodiment of the present invention.

Document mining application 300 is an Information Extraction framework. Ultimately, its task is automatic extraction of entities and relations from free natural language text. The complexity of the task requires it to be split into several stages of different generality and manual intervention requirements.

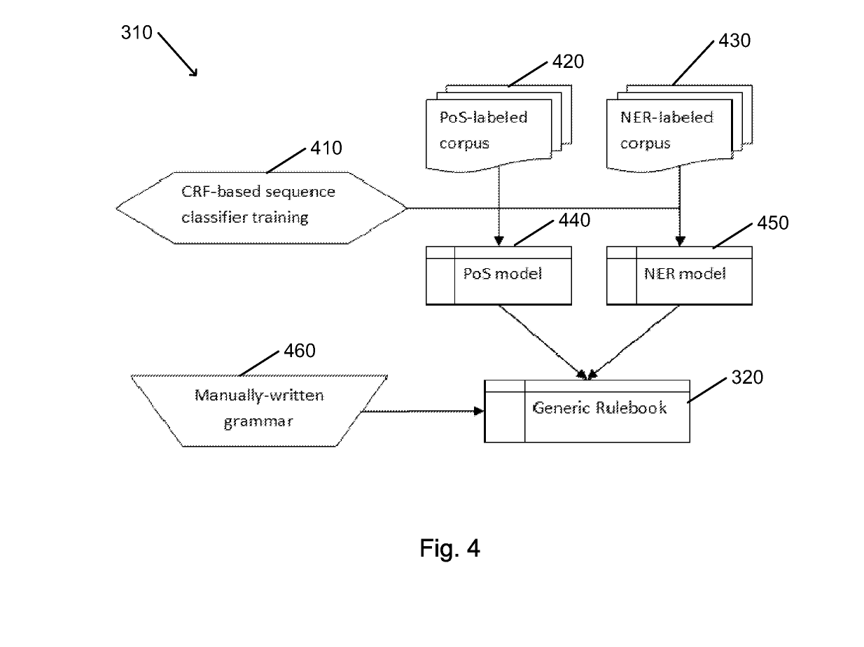

Generic preparation module 310 is concerned with preparing domain-independent linguistic components and outputs generic rulebook 320. FIG. 4 is a schematic diagram of operation of preparation of a generic preparation module of the application for document mining shown in FIG. 3, in accordance with an embodiment of the present invention.

Domain-independent linguistic components include part-of-speech (PoS) model 440 (e.g., created from PoS-labeled corpus 420 using CFR-based sequence classifier training module 410) and named entity recognition (NER) model 450 (e.g., created from PoS-labeled corpus 430 using CFR-based sequence classifier training module 410), as well as a generic (e.g., English) grammar 320, based on HPSG grammar theory, manually-written, e.g. in a language developed for document mining application 300. The output of the generic preparation module 310 is generic rulebook 3200.

Generic rulebook 320 is domain-independent, and is reused in all tasks and domains to which document mining application 300 is applied.

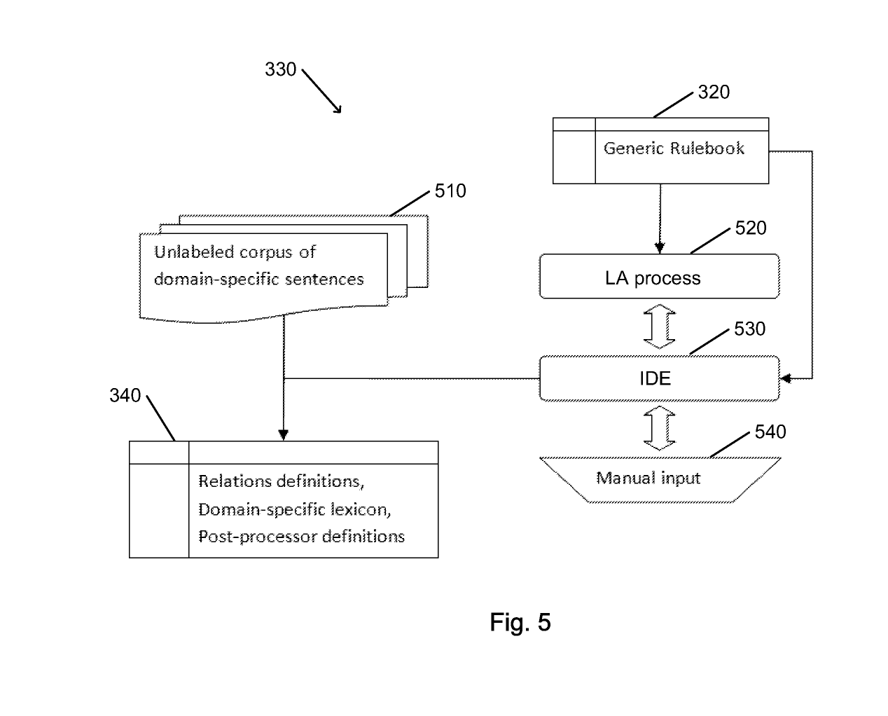

FIG. 5 is a schematic diagram of operation of a domain-specific preparation module of the application for document mining shown in FIG. 3, in accordance with an embodiment of the present invention.

Domain-specific preparation module 330 produces domain-specific output 340 from unlabeled corpus 510 of domain-specific sentences. Domain-specific output 340 may include rulebooks, relation definitions, domain-specific lexicons, and post-processor definitions specific for a particular domain. A domain refers to a particular type of text that refers to a particular type of subject matter. The domain is associated with a particular list of entity and relation types, which are of interest to the end-user and are to be extracted. Preparation of domain-specific output 340 includes operation of lexicon acquisition (LA) process 520 based on generic rulebook 320. Preparation of domain-specific output 340 may also include manual input 540 by a user or operator of document mining application 300. Output of LA process 520 and manual input 540 may be enabled or coordinated by IDE 530 of document mining application 300.

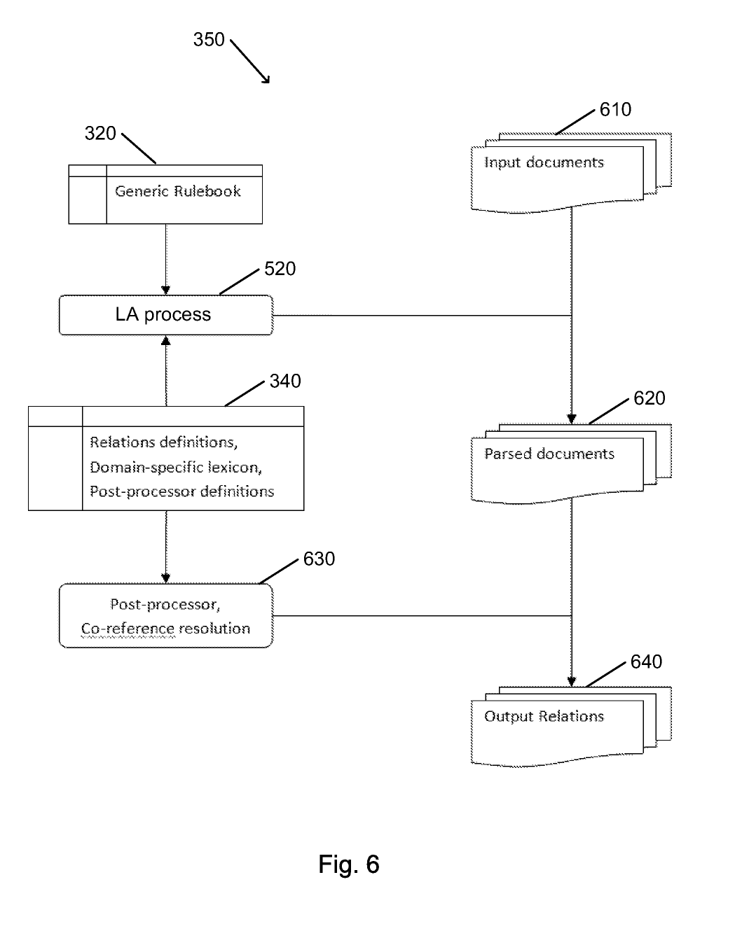

FIG. 6 is a schematic diagram of operation of a information extraction module of the application for document mining shown in FIG. 3, in accordance with an embodiment of the present invention.

Information extraction module 350 processes input documents 610. Relation engine 520 is used to parse input documents 610, using generic rulebook 320 and (e.g., a domain-specific lexicon of) domain-specific output 340, to produce parsed documents 620. Parsed documents 620 are processed by post processor 630 to detect patterns of relations in the parsed documents that may be output as output relations 640.

A document mining project combines information related to development and subsequent use of a domain-specific rulebook. It includes rulebook files, corpora, and post-processor definitions.

Basic project information may be stored in a single main project file, while additional files may be stored in the same directory as the main project file.

A new project may be created by a user command (e.g., from a main menu). A main rulebook file may be created for the project. Typically, the generic rulebook and the included files are stored in a main application directory. However, it is possible to copy them into the project directory, in which case the local files will be used by the project instead. Thus, the generic rulebook may be modified for a specific project without affecting other projects.

Project development may include one or more operations such as: adding domain-relevant corpora to the project; defining entity types that are relevant to the domain, either as wordclass-based entities or directly as manually-written II rules; manually writing other non-standard code ; running a lexicon acquisition process can be run.

When development is complete, the relevant files can be taken from the project files directory and used as engine input for the final information extraction stage. The relevant files consist of the rulebook files and the post-processor definition files.

For example, a main window of an IDE of a document mining application may be a container for various project-related child views. It may include a menu bar, a standard toolbar, and a status bar. Project-related views may become available after a project is opened or created.

Child view windows can be placed in an editor space, docked at one of its sides, or auto-hidden. A standard layout (e.g., created for a new project) may include a large editor space and several views docked at different sides of the main window. Such views may include a log view, a corpus view, a services view, an entity definition view, a relation definition view, an extracted entities view, an extracted relations view, a lexicon view, a rulebook editor view, a sentence collection view, a parse view, and a lexicon acquisition (LA) view. The layout can be changed by moving, closing, and opening new views, and may be saved in a file in the project directory.

Certain user actions may lead to opening of certain views targeted at specific objects. For example, double-clicking on a corpus in the corpus view may open a sentence collection view containing sentences from that corpus. Similarly, double-clicking on a sentence may open a parse view, displaying that sentence's parse. Typically, when the same action is targeted at a different object of the same type (e.g., a different sentence double-clicked), the window is reused, and the new object's view is opened in the same window, while the previous object's view is closed. It is possible to change this behavior if it is desirable to keep the previous object's view open, e.g., by pressing and holding the SHIFT key while performing the view-opening action. Then, the new object's view is opened in a new window, which becomes the reusable one, while the old window becomes independent.

A text editor view may be opened, for example, upon opening a file or a project-related rulebook file, editing a corpus, selecting an entity type in an entity definition view or a relation type in a relation definition view, issuing a navigational command (e.g., “Go To Definition”, “Locate Region”) from an opened editor view, viewing a definition, viewing rules, or under other circumstances. A text editor view may have content-dependent modes, e.g.: a normal text mode; a rulebook file mode with syntax highlighting and code folding; or a read only rulebook regions mode which shows a collection of rulebook fragments, not necessarily continuous. Commands in the text editor view may include, for example, various navigation- or display-related commands.

A corpus view may display a list of corpora (sentence collection files associated with the project), and allows manipulating the corpora. The corpus view may display information related to the identity and status of each displayed corpus. Selection of a displayed corpus may open a sentence collection view, displaying the sentences of the corpus, or enable editing of the corpus or removal from the list. A corpus may be added to the list.

A local corpus may be processed differently from a non-local corpus. For example, a local corpus may be loaded into memory when the project is open, and remain there until it is closed. Its parsed sentences may be stored in human-readable text files, and may be saved periodically when the corpus is being parsed in the background. A non-local corpus, on the other hand, may not be kept in memory, and its parsed sentences may be stored in a packed binary database. Consequently, processing local corpus (that is not too large, e.g., larger than a few thousands of sentences) may be considerably faster that processing a non-local corpus.

A sentence collection view may display a list of sentences from an active corpus, united by some property. For example, sentence collection types may include: local corpus sentences, non-local corpus sentences, entity mentions, relation mentions, or query-based sentence collections that are selected based on user-provided properties. The sentence collection view may display the corpus from which each sentence was taken, and the text of the sentence. If the collection is constructed from specific search criteria, the criteria may be indicated (e.g., by highlighting in the text). A status of the sentence may be indicated (e.g., by a background color). Types of status may include, for example: new sentence, not parsed; successfully parsed sentence, parse obsolete; successfully parsed sentence, up-to-date: sentence with failed parse, up-to-date; and successfully parsed sentence, up-to-date, the parse has changed during the latest rulebook update. Indication of changed parses may be useful during the rulebook development, as it enables viewing of which sentences are affected by rulebook changes. For the affected sentences, the previous parse may be stored and may be displayed in a parse view.

If a sentence is parsed, selecting that sentence may open a parse view.

A parse view may display a parse of the sentence in a tree form. The view may enable interactive highlighting operations to assist in understanding the constituents of parse.

The nodes in tree may include rule nodes, word nodes, and text nodes.

A rule node specifies the grammar rule that created the phrase headed by the node. Common rules may include: XHS - Head-Specifier Rule (HPSG); XHC - Head-Complement Rule (HPSG); XHML, XHMR—Head-Modifier Rule, Left- and Right-side versions (HPSG); XHF—Head-Filler Rule (HPSG), XCoord—Coordination Rule (HPSG); XSent—Sentence Rule (specific to generic rulebook); XA—Appositive Rule (specific to generic rulebook); XLComma, XRComma—Comma Rules, Left- and Right-side versions (specific to generic rulebook); XRelClause—Relative Clause Rule (specific to generic rulebook); and XLParticipleClause, XRParticipleClause—Participle Clause Rule, Left- and Right-side versions (specific to generic rulebook).

A word node specifies the properties and links of words, represented by the leaves of the tree. Each word may be characterized by an identifier (ID), unique within the sentence, a list of properties, and a list of links of the form.

A text node may typically appear as associated with a word node. It is possible for a fragment of text to appear outside words if the engine was unable to include the fragment in the sentence parse. Conversely, it is possible for a word node to be without any text, if the grammar includes zero-length output-producing word rules.

Selection of a word node may indicate, nodes that are linked to it may be indicated, e.g., by highlighting.

The parse view may enable selection of a parse version and indication of relations in the parse.

An entity definition view may display the entity types that are defined by the project's rulebooks, and enable definition of new entity types. The entity view may enable selection of whether an entity type participates in an automatic lexicon acquisition process. If not selected, detected patterns containing the non-selected entity type are discarded. The entity view may display information regarding entities that includes, for example: the name under which the entity instances are to be extracted; allowed values of the entity; and a list of files that contain allowed entity instances.

Selection of an entity type may open a rulebook editor view that displays regions that were identified as related to the entity definition, or may display a list of entity instances. A new entity may be defined by entering an entity type name and a list of entity instances, or a file containing instances of the entity may be selected.

A relation definition view may display a list of relation types that are defined by the project's rulebooks. The relation definition view specifies a relation name under which the relation instances will be extracted; names and types of slots (entities that participate in the relation) may be inferred by analyzing the rulebooks. It may be possible for especially complex definitions to be analyzed incompletely, or even incorrectly, without producing incorrect extraction behavior at processing time. Selection of a relation type may open a rulebook editor view that includes regions that were identified as related to the relation definition, or may display a list of relation instances.

An extracted entity view may display the entities that were extracted, using the project's rulebook, from the active corpora, as well as the number of times each entity is included in the active corpora. The entities list can be sorted either by count or alphabetically. Selection of an entity instance may open a sentence collection view displaying those sentences that include the entity.

An extracted relations view displays the relation types extracted using the rulebook from the active corpora, as well as the number of times each relation is included in the active corpora.

Selection of a relation instance may open a sentence collection view displaying those sentences that include the relation.

A lexicon view may display a list of lexical entries that are defined by the project's rulebook. Words may be grouped as verbs, nouns, or others (other groups are possible). If a word has more than one definition, all of the senses may be listed separately (e.g., distinguished by a number). Selection of a word may display the definition in a rulebook editor view.

Lexicon acquisition refers to a set of techniques, algorithms, and GUI features that enable creation of domain-specific rulebooks and post-processor definitions automatically, or semi-automatically, by analyzing a corpus of unlabeled sentences known to be relevant to the domain. Lexicon acquisition includes, for example, identifying interesting relations between entities, and creating relation definitions, as well as identifying new words relevant to the domain, creating feature structures for them, and adding them to the lexicon.

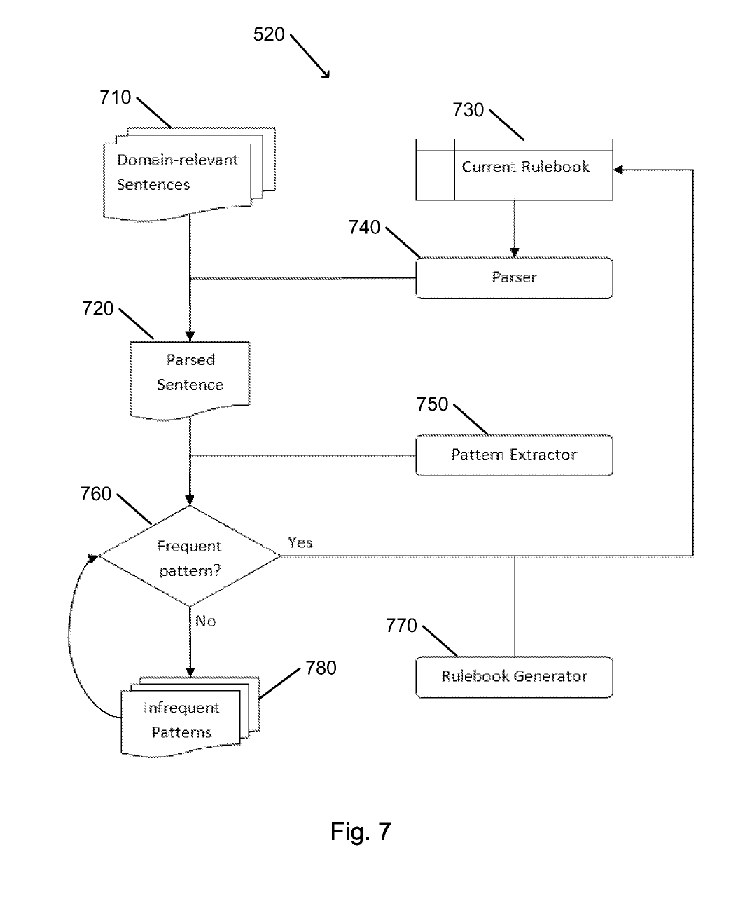

FIG. 7 is a schematic diagram of operation of a lexicon acquisition process of the application for document mining shown in FIG. 3, in accordance with an embodiment of the present invention.

In LA process 520, each of domain-relevant sentences 710 from the corpus are parsed by parser 740 to a parsed sentence 720, in accordance with current rulebook 730. Each parsed sentence 720 is analyzed by pattern extractor 750. If a suitable candidate pattern is found, the candidate pattern is checked by pattern checker 760 against infrequent pattern list 780, which lists the infrequent patterns that were extracted up to that point. If the pattern was encountered a sufficient number of times (e.g., more than a threshold number, e.g., 2, indicating the pattern to be a frequent pattern), the pattern is sent to rulebook generator 770. Rulebook generator 770 incorporates the pattern as a new relation, and creates the lexicon entries (code) necessary for extracting it. The resulting code is appended to current rulebook 730, and LA process 520 continues. Note, that updating current rulebook 730 may result in a parsed sentence 720 of one or more of domain-relevant 710 sentences becoming outdated. For example, the parse a sentence that contains a word, whose definition was changed by the update, may no longer be correct. Thus, a displayed number of parsed sentences may increase or decrease during operation of LA process 520.

A pattern may be successfully identified by pattern extractor 750 when the pattern is syntactically sound, matching one of the common linguistic templates, and when the pattern is semantically relevant, connecting at least two different currently enabled entities. Successful pattern identification may depend on the complexity of the input sentence. Since the amount of ambiguity in natural language is very large, in the absence of domain-specific syntactic and semantic information, a generic grammar may make mistakes in parsing a complex sentence. However, if a correct pattern learned (for example, from a simpler sentence), then the additional information it provides may be sufficient to enable correct re-parsing of the original complex sentence. Therefore, a sufficiently large corpus of sentences may provide at least some sentences that are sufficiently simple to enable correct parsing. On the other hand, a corpus that is too large may be undesirable, both due to performance considerations and due to increased production of noise (patterns generated by errors or by random fluctuations).

The patterns, and the relations that are generated from them, may be named automatically, using the patterns content. For example, in one convention, relation names may start with the prefix “Rel_”, followed by words participating in the pattern in order of their appearance in the syntactic template. (The order of words in the syntactic template may differ from their order in the source sentence, for example, if the pattern in the sentence occurs in the passive voice.) The words are separated by the underscore character. The participating entities are substituted by their types in the generated relation name.

A relation mapping mechanism may enable a post-processor to rename a relation and its slots before creating the final output. Thus, meaningful names may be provided for both a relation and its slots. Similar relations may be clustered by mapping different relations onto a single final output relation.

Mapping of relations may occur during the post-processing, and thus does not affect rulebooks or LA process 520. The relations created by mapping are altogether separate from the regular rulebook relations, and may be referred to as mapped relations.

Some slots of a relation may be optional. Such optional slots are usually represented in language by modifiers—syntactic constructions that add to the semantics of a head phrase without significantly changing its syntactic properties. A lexicon acquisition algorithm may be configured to identify and extract the common modifier forms, such as preposition phrase modifiers and compound noun modifiers.

Modifier patterns (“modifiers”) are similar to regular patterns, but have a distinct feature: each modifier has a ‘connector site’, which must attach to a suitable head phrase, which must be part of a basic pattern. Depending on the properties of the connector site, the modifiers may be classified as: verb modifiers, which connect to verbs; common noun modifiers, which connect to specific common nouns; and entity modifiers, which connect to entities of specific types.

Verb and entity modifiers are always preposition phrases, while common noun modifiers may also be compounds.

The modifier patterns may be given distinct names. For example, in one convention, verb modifiers start with the prefix “Mod_verb_”, common noun prepositional modifiers start with the prefix “Mod_nnnn_” (where nnnn represents the noun), common noun compound modifiers start with “Mod_nnnn_x_”, and entity modifiers start with “Mod_EEEE_”, where EEEE is the entity type.

When a basic relation with a modifier is extracted, the slot carried by the modifier receives the name equal to the modifier name. Like other slot names within a relation, it can be mapped.

A lexicon acquisition console (LAC) view may display the current status of the lexicon acquisition process, and enable a user to intervene in the process.

For example, the LAC view may display a tree with nodes of many types and with many different functions, and a set of context-dependent controls.

At the beginning of the LA process, the tree is altogether empty. As the process continues, new patterns may be identified and added to the tree, at first as infrequent patterns. Sentences, from which the patterns were extracted may be displayed as child nodes of the pattern nodes.

As more sentences get processed, the recurring frequent patterns may be discovered, which become reclassified as relations and are displayed as basic relations (instead of as infrequent patterns).

With regard to infrequent patterns and unmapped basic relations, the user may, for example; select an infrequent pattern to be reclassified as a relation without waiting for more occurrences; rename or map a relation; delete an infrequent pattern or unmapped basic relation; or undelete a deleted pattern or relation.

In renaming a relation, a user may be requested to specify a new name for the relation and its slots. When a mapped relation is created, other basic relations can be mapped or merged into it. The merging of relations may be reversed.

The LA process algorithm may begin to identify modifiers after a pattern is reclassified as a relation. In a manner similar to patterns, modifiers may at first be classified as infrequent modifiers. When a particular modifier appears a sufficient number of times, it is reclassified as a modifier. When modifier is deleted, it may be classified as a disabled modifier.

An individual modifier may be displayed more than once in the LAC tree. For example, modifier and disabled modifier nodes may be displayed not only as root nodes, but also as children at every relation level: under unmapped basic relations, under mapped relations, and under merged basic relations (whose nodes are children of mapped relations nodes).

A modifier, when it is first reclassified, may be displayed as a modifier node of every relation to which the modifier potentially applies. A modifier potentially applies to a basic relation if the relation contains a place matching the modifier's connector site. For example, a “Mod_verb_*” modifier may apply to any verb-based relation, while a “Mod_acquisition_x_*” modifier may apply to any relation whose pattern contains the noun “acquisition”. A modifier potentially applies to a mapped relation if it potentially applies to any of the basic relations merged into it.

1. A document mining method comprising:
automatically parsing each sentence of a corpus of documents into constituents, and, if some of said constituents of the sentence correspond to entities from a list of recognized entity types, automatically identifying a relation between those entities, the relation including the entities and a link between them; and
if the relation is identified in a predetermined number of sentences of the corpus, automatically creating a relation extraction rule that is applicable to a document to enable automatic retrieval of information that corresponds to the relation from that document.

2. The method of claim 1, wherein automatically parsing each sentence comprises applying a rulebook to each sentence.

3. The method of claim 2, further comprising modifying the rulebook in accordance with a recurring pattern that is detected in a set of domain-relevant sentences.

4. The method of claim 3, further comprising re-parsing a sentence after modification of the rulebook.

5. The method of claim 1, wherein the relation extraction rule comprises a set of head-driven phrase structure grammar (HPSG) lexicon entries.

6. The method of claim 1, wherein the corpus of documents is a local corpus.

7. The method of claim 1, wherein the corpus of documents is accessible via a network.

8. The method of claim 1, further comprising identifying and creating an extraction rule for a modifier of the identified relation.

9. The method of claim 1, further comprising receiving from a user the list of recognized entity types.

10. The method of claim 1, further comprising automatically naming the relation.

11. The method of claim 1, wherein creating the relation extraction rule comprises automatically clustering a plurality of the identified relations in accordance with similarity criteria.

12. A document mining method comprising applying a relation extraction rule to a sentence of a document to extract a relation regarding one or more entities that are named in the sentence, the relation extraction rule created by automatically detecting patterns of identified relations among recognized entity types in parsed sentences of a corpus of documents.

13. The method of claim 12, wherein sentences of the corpus of documents are parsed to form the parsed sentences by application of the rulebook to the sentences.

14. The method of claim 13, wherein the rulebook is modified after detection of the patterns.

15. The method of claim 14, wherein a sentence of said sentences of the corpus of documents is re-parsed after the rulebook is modified.

16. The method of claim 12, wherein the relation extraction rule comprises a set of head-driven phrase structure grammar (HPSG) lexicon entries.

17. A document mining system comprising a processor, the processor being in communication with a computer readable medium, wherein the computer readable medium contains a set of instructions wherein the processor is further configured to carry out the set of instructions to:
automatically parse each sentence of a corpus of documents into constituents, and, if some of said constituents of the sentence correspond to entities from a list of recognized entity types, automatically identify a relation between those entities, the relation including the entities and a link between them;
automatically create a relation extraction rule that is applicable to a document to enable automatic retrieval of information that corresponds to the relation from that document, if the relation is identified in a predetermined number of sentences of the corpus; and
apply the relation extraction rule to a sentence of a document to extract a relation regarding one or more entities that are named in that sentence.

18. The system of claim 17, wherein the processor is configured to access the corpus of documents via a network.
